(19) United States
(12) Patent Application Publication
(10) Pub. No.: US 2007/0187022 A1
(43) Pub. Date: Aug. 16, 2007

(54) Device and method for stiffening a web destined to be wound in logs

(75) Inventors: Mauro Biagioni, Lucca (IT); Sergio Casella, Fornoli Lucca (IT)

Correspondence Address: GREER, BURNS & CRAIN, 300 S WACKER DR, 25TH FLOOR, CHICAGO, IL, 60606, US

(73) Assignee: Paper Converting Machine Company

(21) Appl. No.: 11/654,060

(22) Filed: Jan. 16, 2007

(30) Foreign Application Priority Data
Jan. 27, 2006 (IT) MI 2006A 00144

(51) Int. Cl. B32B 3/00

(52) U.S. Cl. 156/227; 428/156; 428/212

(57) ABSTRACT

A stiffening device for a web destined to be wound in a log by a winding unit of a re-winding machine forms on the web at least one longitudinal strip of greater thickness, so as to obtain in the log at least one sector with a greater stiffness to avoid deformation of the log during winding.

### RELATED APPLICATION

Applicants claim priority of Italian Patent Application No. MI 2006A 00144, filed Jan. 27, 2006.

### BACKGROUND

The present invention refers to a device and a method for stiffening a web destined to be wound in a log. Such a device is particularly suitable to be placed upstream of a rewinding machine for winding logs of web material, particularly paper, such as toilet paper, tissue paper and the like.

In rewinding machines with a peripheral winding system, the log winding stage takes place by inserting a tubular cardboard core into a winding cradle of the machine. The winding cradle is defined between three rollers, two of which are fixed and one movable. The movable roller follows the increase in diameter of the log being formed. The paper web winds around the core carried in rotation by the three rollers in contact on the outer surface firstly of the core and subsequently of the log being formed.

Discharge of the log takes place by creating a sudden difference in speed between the winding rollers so as to cause the log to be expelled from the winding cradle.

This winding system shows some limits when soft logs with a reduced paper density are being produced. Such soft logs are obtained by reducing the amount of paper wound in a log of a given diameter through the law of motion of the winding pressure roller, that is, by increasing the speed of growth of the diameter defined by the three rollers in relation to the final diameter of the log and to the feeding speed of the paper, and/or by reducing the tension of the paper being wound, that is, by creating a difference in speed between the peripheral winding speed and the feeding speed of the paper web. Production of this type of products, with product quality complying with the manufacturer's specifications, is possible only by reducing the winding speed, with a consequent reduction in the productivity of the machine.

In fact, during winding, the winding rollers, at the point of contact with the log, do not encounter sufficient resistance to compression and deform the rotating log which becomes strongly unbalanced. Moreover, the tubular cores have more or less marked flexures according to their bending stiffness as shown in FIG. 9 in which the real, flexed core is shown with a dashed line and the ideal core with a solid line. Therefore dynamic forces arise on the log and increase with the speed of rotation. As a consequence:
Winding is not even and therefore the density of the paper varies within the section of the log. This unevenness can vary with the cross-section of the log examined.
Eccentricity of the core is generated with respect to the section of the roll. This eccentricity can vary in the different cross sections of the log examined.
Deviations in the circularity of the outer surface of the log are created. This deviation can vary in the different cross sections examined.
Extraction of the log obtained by creating a sudden difference in peripheral speed between the winding rollers is less effective with soft logs, because of the smaller contrast pressure that can be exerted by the rollers.

There are also drawbacks in gluing of the end edge of the log in the gluing machine situated downstream of the rewinding machine. In fact the gluing system comprises the following stages:
setting the log in rotation, usually between two rollers (edge preparing rollers), to identify and unwind a portion of the edge;
spreading glue on the unwound edge;
setting the log in rotation, usually between two rollers (edge closing rollers), to rewind the log and bring the edge into contact with the wound material.

This gluing system is less effective with soft logs because of the smaller contrast pressure that can be exerted by the preceding rollers on the log.

The above described manufacturing defects mean that the product does not comply with the required quality specifications and performance of the machine is limited because of the reduction in speed and the difficulties in managing the discharge and edge gluing stage.

FIG. 8 shows shift and circularity errors in the production of “soft” logs. If the tubular core A with its center at O′ is considered, the profile of the outer surface of the theoretical log should theoretically be that represented with a dashed line and indicated by X′ which has its center at O′. However, in practice the profile of the outer surface of the real log is that shown with a solid line and indicated by X which has its centre at O. The eccentricity between the center O′ of the core A and the center O of the profile X of the outer surface of the real log can be detected.

To overcome this drawback rewinding machines have been produced which combine with the peripheral log winding unit chucks which are inserted into the ends of the core, during the introduction stage, in order to keep the axis of the core coaxial with that of the log being formed. However, this method and device present some drawbacks.

Such a device is complex because it must allow management of the movements of extraction and return of the chucks, the movement to follow the trajectory of the core during the introduction stage, and the movement to follow the trajectory of the axis of the log during formation, due to the increase in diameter of said log.

The time needed for insertion of the chucks, during the core introduction stage, increases the total time needed to perform this stage, consequently limiting the number of changes (number of cores introduced into the winding chamber in the unit of time—minute).

In order to prevent the time for return of the chucks to the core catching position at the end of winding from increasing the introduction times, it is necessary to have a second pair of chucks, with a further increase in the complexity of the device and the relative costs.

### SUMMARY OF THE INVENTION

An object of the present invention is to overcome the drawbacks of the prior art by providing a device and a method for stiffening of a web destined to be wound into logs, that are able to ensure correct winding of the log, reducing production times and avoiding the use of additional devices which lead to greater complexity of management and higher costs.

This object has been achieved in accordance with the invention with the characteristics listed in appended independent claims.

Advantageous embodiments of the invention are apparent from the dependent claims.

The stiffening device according to the invention is able to create on the web at least one longitudinal strip with greater stiffness, and is destined to be placed upstream of a winding unit so as to obtain in the log formed in the winding unit at least one sector with a greater stiffness to avoid deformation of the log during winding.

The method provides for the creation of sectors of the log, generally two at the outer ends of said log, with a greater density. In this manner the pressure exerted on the log by the winding rollers is sustained by these sectors with a greater stiffness, reducing deformation of the log. A winding condition similar to that obtained in the production of products with a standard density is thus created.

The coaxiality between the axis of the core and the axis of the section of the log and the circularity of the section of the log are thus guaranteed to come within the specific tolerances of the peripheral winding process. Furthermore, with this method the performance of the machine is not reduced as far as the winding speed and the number of changes are concerned, in that there are no elements that interact in this stage of introduction and winding of the log.

Furthermore, discharge of the log from the rewinding machine at the end of winding and gluing of the terminal edge of the log in the gluing machine takes place with a similar efficiency to that obtained in the production of logs with standard density.

This system of stiffening of longitudinal strips of the web provides advantages not only for winding of the log but also for improving management of the paper tension during processing of webs of soft paper with a greater volume of sheet products obtained by means of a particular process called TAD (Through Air Dried). In fact the drawing pressure roller unit (a pair of rollers, one of which is high-grip to tension the paper web downstream of the folding unit) exerts a higher pressure on the strips of web with a greater thickness, obtaining greater control of the web. This condition leads to an advantage, also considering that during processing of some of the aforementioned products excessive generalized pressure on the whole width of the web would cause mechanical stress and a reduction in the volume of the paper which would be unacceptable for the purposes of the quality of the product.

It should be noted that the stage of creating portions of web with a greater thickness and density can be generated upstream of the rewinding machine, by creating a unit/machine specially dedicated to this operation. Alternatively, it is possible to install the stiffening device in the rewinding machine upstream of the drawing pressure rollers, to exploit the better paper tension managing capability, and in any case before the winding unit.

In the extreme condition the web could be folded before the unwinding machine, and thus at the beginning of the transformation line, to exploit the better paper tension control throughout the line.

### DESCRIPTION OF THE DRAWING

Further characteristics of the invention will be made clearer by the detailed description that follows referring to a purely exemplifying and therefore non-limiting embodiment thereof illustrated in the appended drawings, in which:

FIG. 1 is a perspective view of a winding unit of the rewinding machine in which a log is wound wherein three sectors with greater stiffness have been created, two at the outer edges and one intermediate, according to the invention;

FIG. 2 is a diagrammatic view of an embodiment of the system for stiffening strips of web according to the invention;

FIG. 3 is a plan view taken in the direction of the arrow D of FIG. 2;

FIG. 4 is an enlarged view of a detail of FIG. 3 illustrating a sensor unit, in which two possible positions of the side edge of the web are shown with a dashed line;

FIG. 5 is a perspective view illustrating a detail of the folding unit for the side edge of the web, in the folding condition;

FIG. 5A is a perspective view like FIG. 5, but illustrating the folding unit in the non-folding condition;

FIG. 6 is a perspective view illustrating an embodiment of a central strip of stiffening of the web;

FIG. 7 is a perspective view illustrating a further embodiment of a side strip of stiffening of the web;

FIG. 8 is a diagrammatic cross sectional view illustrating the shift and circularity error in production of logs according to the prior art; and

FIG. 9 is a diagrammatic cross-sectional view illustrating bending of the core of a log according to the prior art.

### DESCRIPTION OF SPECIFIC EMBODIMENTS

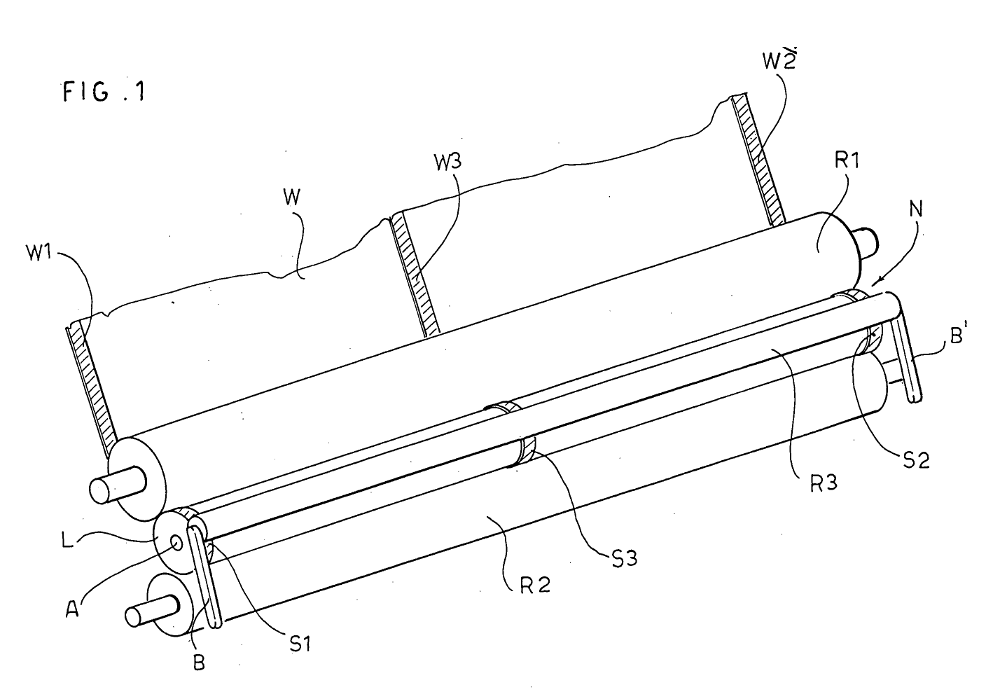

FIG. 1 shows a winding cradle N of a rewinding machine. The rewinding cradle N is a gap created between a set of 3 rollers: a first winding roller R1, a second winding roller R2 and a movable roller R3, commonly known as a pressure roller. In the winding cradle N a log L of sheet or web material W, generally paper, is wound on a tubular core A.

The peripheral surface of the winding rollers R1, R2 is always in contact with the peripheral surface of the log L. The pressure roller R3 follows the growth in diameter of the log L being formed. For this purpose the pressure roller R3 is supported by two arms B, B′ hinged in respective fulcra in the sides of the machine.

The web W which is fed towards the winding cradle N has two longitudinal strips with greater stiffness W1, W2 at its side edges and a strip with greater stiffness W3 disposed along its midline. However, in relation to the device with which this greater local stiffness is obtained, further stiff longitudinal strips can be obtained in intermediate areas of the web W. As a result, the log L will have two rigid circular sectors S1 and S2 at its side edges and a circular rigid sector S3 in its middle part.

The creation of sectors with a greater thickness S1, S2, S3 can be achieved substantially by locally increasing the density of the web W upstream of the winding cradle N. This can be obtained with various systems. Some systems for stiffening the web W are described hereunder by way of example.

Folding of the web W can be performed at its edges, as it travels, upstream of the winding and introduction area N, creating overlapping of the side edge of the web, for a portion W1, W2 having a width that can be adjusted between 5 and 50 mm. In this manner the log being formed will have a greater density at its extremities, in that the paper is superimposed.

By keeping the web folding device active for the entire winding stage, it is possible to achieve a density increase of 100% in the cross sections, at the extremities of the log. It is also possible to activate and stop the folding device during the winding stage, in order to manage this density value and thus the resistance to compression exerted on the log L by the winding rollers R1, R2 and the pressure roller R3.

In addition or as an alternative to folding of the web W, longitudinal strips W1, W2, W3 at the extremities of the web and/or intermediately, from 5 to 50 mm wide, can be starched and embossed or knurled while the web W travels, or as an alternative to starch other chemical substances suitable for stiffening of the web can be added so that the profiles obtained by embossing or knurling are maintained. Embossing can be performed before or after application of the starch. In this manner the web W will have a greater stiffness due to the presence of the starch and a greater thickness due to the embossing or knurling. Sectors S1, S2, S3 with a greater stiffness and density are therefore obtained in the log L being wound.

In addition or as an alternative to the above described systems, applied material can be added along longitudinal strips W1, W2, W3 at the outer edges of the web and/or intermediately, between 5 and 50 mm wide, while the web travels in the rewinding machine. In this manner the assembly of web W and applied material will have greater stiffness and greater thickness. Sectors S1, S2, S3 with greater stiffness and density are thus obtained in the log L being wound.

This can be obtained, for example, by depositing on the web W a strip of paper—or material with a greater weight and thickness—and coupling the two layers by means of embossing or knurling or other procedures (spreading of glue, electrostatic charge, and the like). In this manner the two layers are prevented from separating before reaching winding. The applied material can also be liquid material to be distributed on the strips of the web W1, W2, W3 so as to increase the thickness and give greater consistency, particularly through spreading of thick liquid glue.

To create sectors at the outer edges of the log and internal sectors a combination of the preceding methods can be used, such as for example, the procedure of folding at the outer edge of the web to create the outer sectors and starching of the web to create the inner sectors.

Subsequently during cutting of the log, in the cutting-off machine, according to per se known procedures, the trimming width at the edges of the log will be adjusted so as to eliminate the outer sectors with greater stiffness. It will also be possible to adjust the cut so as to discard any intermediate sectors with greater thickness too.

The greater waste of product that occurs in this procedure with respect to the current one (greater width of the trimmed edges and possible intermediate sector) is amply compensated for by the greater productivity of the rewinding machine. In fact it must be considered that the discarded sectors are in any case recovered as raw material for paper manufacturing.

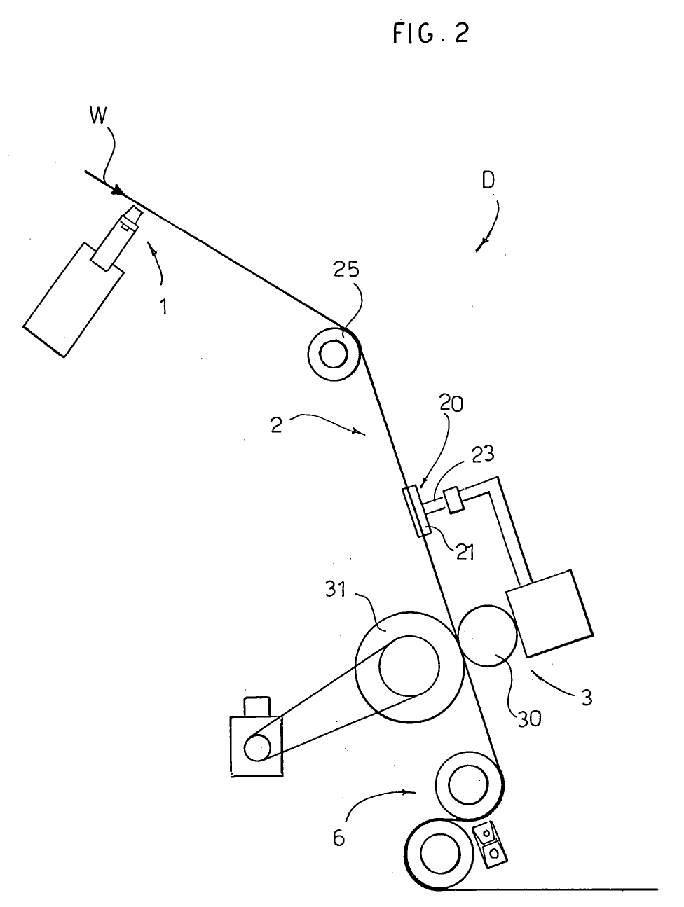

An embodiment of the stiffening device designated as a whole with reference numeral 100, which allows stiffening of longitudinal strips W1, W2 at the outer edges of the web W to be created through folding of the side edges of the web W, is described hereunder with reference to FIGS. 2-6.

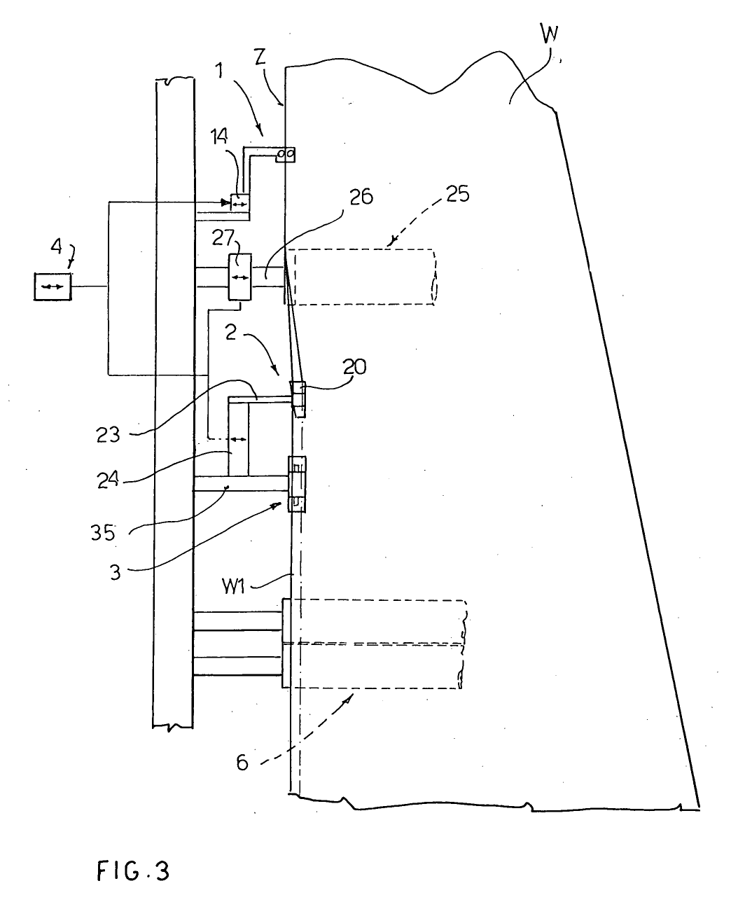

As shown in FIGS. 2 and 3, the stiffening device 100 comprises:
a sensor unit 1 to detect the position of the side edges of the web W,
a folding unit 2 to fold the side edges of the web W,
a plybonding unit 3 to join the folded, superimposed side edges of the web W, and
a control system 4 (FIG. 3) to control the position of the sensor unit 1, of the folding unit 2, and of the plybonding unit 3.

The stiffening device 100 is inserted upstream of a drawing pressure roller unit 6 which is part of the rewinding machine, or even upstream of said rewinding machine, so as to represent a module of the production line distinct from the other machines.

For the sake of simplicity of the description, reference will be made to only one side edge of the web, it being understood that the stiffening device 100 is provided on both side edges of the web.

The stiffening device 100 is inserted upstream of the winding unit R1, R2, R3 of the rewinding machine.

During unwinding from the parent roll, transverse shifts of the web W occur in both directions. That is to say, the longitudinal axis of the web W undergoes shifts of the order of 10-30 mm with respect to the theoretical axis of the parent roll. This is due to a tolerance present in winding of the parent roll, to the gripping system of the parent roll in the unwinding machine, and to transverse movements of the log L in the winding cradle N, since it is not constrained transversally.

The folding unit 2 must always act at the outer edges of the web W to ensure that the width of the edge is constant when the machine is in operation and that the web travels towards the winding area. For this purpose the following two solutions can be adopted alternatively or jointly to achieve greater precision.

The first solution consists in providing systems for transverse movement of the gripping punches of the parent roll in order to keep the axis of the web centered; movement will be managed by sensors that detect shifting of the edge and consequently order a transverse shift of the roll so as to compensate for the preceding one. These devices are commonly adopted on unwinding machines and are therefore devices coming within the prior art. In this case the folding unit 2 and the plybonding unit 3 will generally be fixed integrally to the machine structure by means of suitable supports and brackets.

The second solution provides for the folding unit 2 and the knurling unit 3 to be moved in harmony with the transverse movement of the web W. For this purpose it is necessary for the stiffening device 100 to be integrated with the sensor unit 1 preferably installed upstream of the folding unit 2.

The folding unit 2 comprises a folding roller 25 and a folding plate 20; the unit must always act on the edge of the web W to ensure that the width of the folded and superimposed side edge W1 is always respected. Therefore, the folding unit 2 must move on the same direction of the web W.

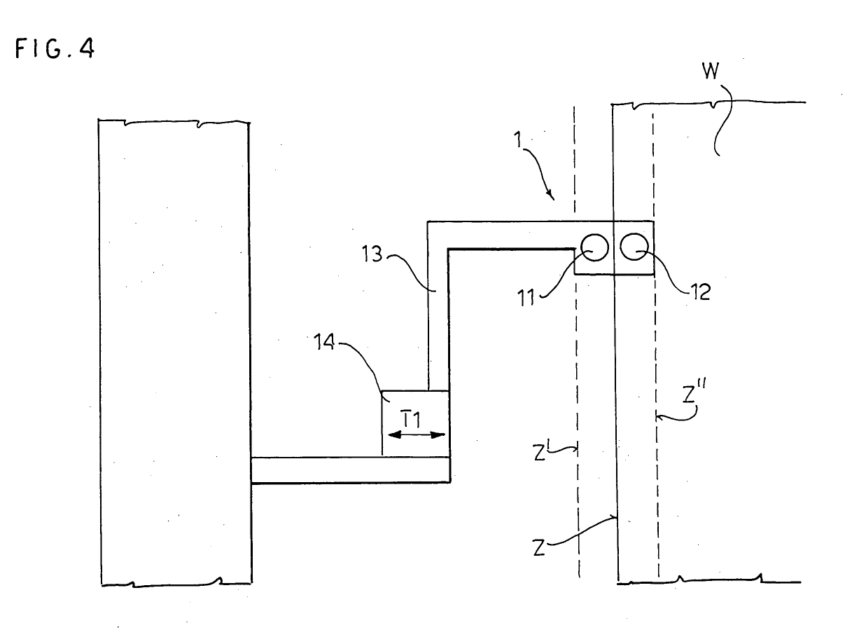

For this purpose a sensor unit 1 is installed to detect the edge of the web W. As shown in FIG. 4, the sensor unit 1 comprises two sensors 11, 12 disposed at a short distance from each other, one next to the other. These sensors 11 and 12 are mounted on an arm 13. The arm 13 can be driven in translation by a linear actuator 14 so as to be able to move in a transverse direction indicated by the arrow T1. The sensor unit 1 can thus move transversally to follow shifting of the web W.

As shown better in FIG. 3, the folding plate 20 is mounted on an arm 23. The arm 23 can be driven in translation by a linear actuator 24 so as to be able to move in a transverse direction. The folding roller 25 is also mounted on an arm 26 driven by a linear actuator 27 to be able to move in a transverse direction. The folding unit 2 can therefore move transversally in order to follow the movement of the web W. Furthermore, the plybonding unit 3 is mounted on an arm 35 driven by the same linear actuator 24 of the folding plate 20.

As shown in FIG. 3, the linear actuators 14, 27 and 24 of the sensor unit 1, of the folding unit 2 and of the plybonding unit 3 are operatively connected to the control unit 4.

Returning to FIG. 4, the side edge of the web W in correct working conditions is indicated by Z. Z′ and Z″, on the other hand, indicate the side edge of the web in different positions following transverse movements thereof.

In correct working conditions, the edge Z of the web W is situated between the two sensors 11 and 12. Thus, in this condition, the first sensor in 11 does not detect the web W, whereas the second sensor 12 detects the presence of the web W.

Should the edge move into the position Z′ because of the transverse movements of the web W, both sensors 11 and 12 detect the presence of the web W and a control signal is accordingly sent to the control and management unit 4. Thus, the control and management unit 4 controls the linear actuator 14 to move the sensor unit 1 towards the inside of the side of the machine, until the first sensor 11 leaves the field of detection of the web W, restoring the correct working condition.

At the same time, the control unit 4 also controls the linear actuators 24 and 27 of the folding unit 2 and of the plybonding unit 3 to obtain an identical movement (in direction and size) of the folding roller 25, of the folding plate 20 and of the plybonding unit 3.

In a similar manner, if the edge of the web W is in position Z″, neither the first sensor 11 nor the second sensor 12 detects the web W and accordingly they send a control signal to the control unit 4. The control unit 4 then controls the actuator 14 and the sensor unit 1 moves towards the outside of the side, until the second sensor 12 enters the field of detection of the web W, restoring the correct working condition.

At the same time the control unit 4 controls the linear actuators 24 and 27 of the folding unit and of the plybonding unit so as to have an identical movement (in direction and size) of the folding roller 25, of the folding plate 20 and of the plybonding unit. In this manner the edge Z of the web W will be folded on itself by an approximately constant amount throughout the work cycle. Sampling of information by the sensors 11 and 12 and the consequent adjustment will be performed continuously during the cycle.

The transverse movement of the sensor unit 1, of the folding unit 2, and of the plybonding unit 3 takes place along linear guides and can be controlled by only one linear actuator or by a plurality of independent linear actuators.

The transverse movement of the sensor unit 1 can take place by fixing the sensor support on carriages sliding along linear guides and controlled by the linear actuator 14. Transverse movement of the folding roller 25 and of the folding plate 20, and possibly of the plybonding unit 3 can, in this case too, take place by installing their supports on carriages sliding on linear guides controlled by linear actuators 27 and 24. In relation to the relative distance between the units 1, 2, 3, these can be integral with each other. In the figures the plybonding unit 3 is shown integral with the folding plate 20.

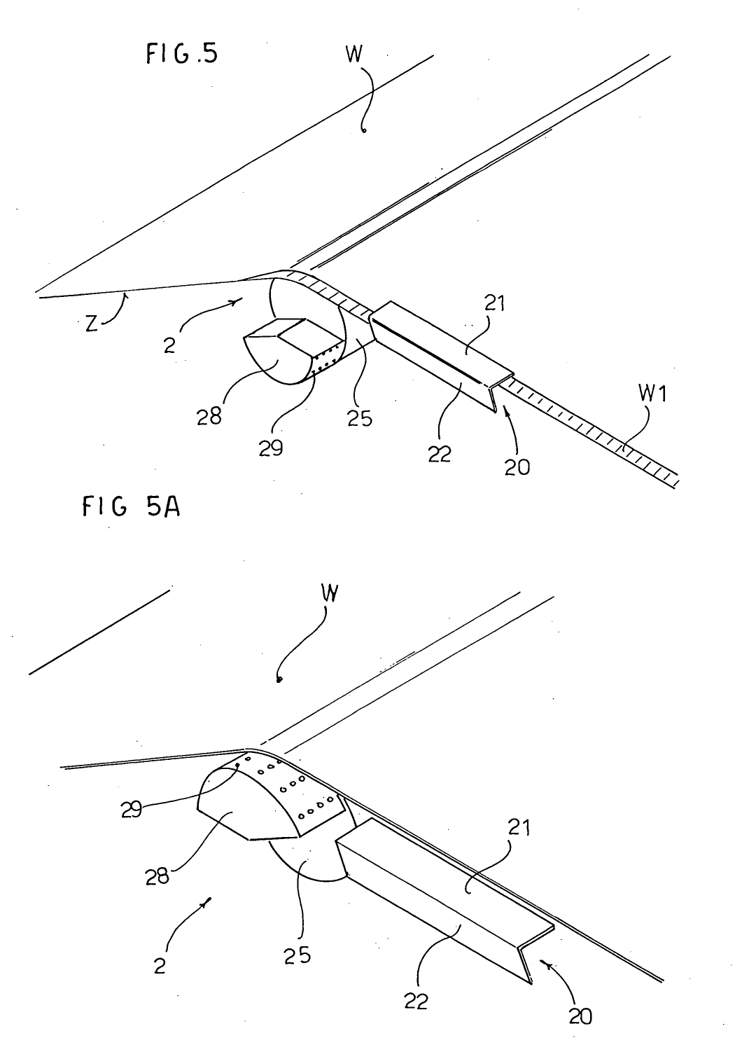

FIGS. 5 and 5A show the folding unit 2 in the folding condition and in the non-folding condition, respectively.

The folding unit 2 comprises the folding roller 25 and the folding plate 20. The folding roller 25 has a length that is smaller than the width of the web W and is disposed so that the edge Z of the web W protrudes with respect to its outer side by an amount equal to the width of the stiffening strip W1 that is to be obtained. In this manner, on leaving the folding roller 25, the side edge Z of the web W is folded substantially 90° downwards through the effect of the change in direction and pulling of the web. The folding plate 20 is substantially V-shaped in cross section and comprises a horizontal portion 21 and an oblique portion 22 disposed at an angle of about 80° with respect to the horizontal portion 21.

At the exit of the folding roller 25 the first folding of the side edge of the web W begins, said folding continuing and being guided in the folding plate 20, so that the side edge of the web is folded 180° and is placed beneath the web, through the change in direction of the paper on leaving the roller and in the speed of pulling of the paper. Thus on leaving the folding plate 20 the stiffening strip W1 having double the thickness of the web W is obtained.

This folding stage can be achieved with other solutions, for example with folding plates with a progressive section, combining plates with a suitable section with air jets, to facilitate the folding movement of the side edge of the web W, and/or with web suction points to facilitate adhesion of the side edge of the web to a surface of the plate 20.

It may be necessary during winding to activate and stop folding of the side edge of the web W, so as to adjust the density of the sectors S1, S2 of the log involved. To this end a circular supporting section 28 for the web W is mounted on the ends of the folding roller 25 and can be rotated to bring itself into a position supporting the web W and avoid folding thereof. As shown in FIG. 5A, in this condition the folding plate 20 will translate outwards so as not to interfere with the web W.

The supporting sector 28, remaining fixed during travel of the web W, will have to be made of low friction material such as polyzene, ertalon, teflon or the like, in that friction between the paper web and the supporting sector 28 is greater than that existing between the paper web and the folding roller 25 which is rotating.

In order to further reduce friction between the supporting sector 28 and the web W it is possible to make a series of holes 29 distributed on the contact surface. Jets of air leave the holes 29 in the supporting surface 28, through a connection with the compressed air circuit of the machine (not shown in the figure). In this manner an air cushion is created between the web W and the surface of the supporting sector 28 which offers reduced resistance to sliding.

Returning to FIG. 2, the plybonding unit 3 comprises a plybonder roller 30, commonly known as a plybonder, and a motorized anvil roller 31. The plybonder roller 30 and the anvil roller 31 are subjected to a working pressure. The superimposed side edge W1 of the web is joined through the pressure exerted as is passes through the plybonding unit 3, exactly through the pressure exerted by the plybonder 30 on the anvil roller 31.

This stage of joining the edge of the web is necessary in that it can happen that the folded and superimposed side edge W1 of the web can re-open, before reaching the winding area C. In this manner joining of the side edge of the web is ensured.

The plybonding unit 3 shown has only one motorized roller 31. It is possible to motorize both rollers 31, 30 to improve insertion and exclusion of the plybonding unit 3 with the web W in movement, with a greater guarantee of avoiding possible breaking of the web W. As an alternative or in addition to the plybonding or embossing unit 3, other systems can be used, such as:
inducing an electrostatic charge on a portion of the web before the folded side edge is superimposed, so as to ensure adhesion thereof until winding,

application of glues—spray or liquid—on a portion of the web before the folded side edge is superimposed, so as to ensure adhesion until winding.

Other systems that can be implemented to create sectors S1, S2, S3 of log with a greater stiffness are described hereunder.

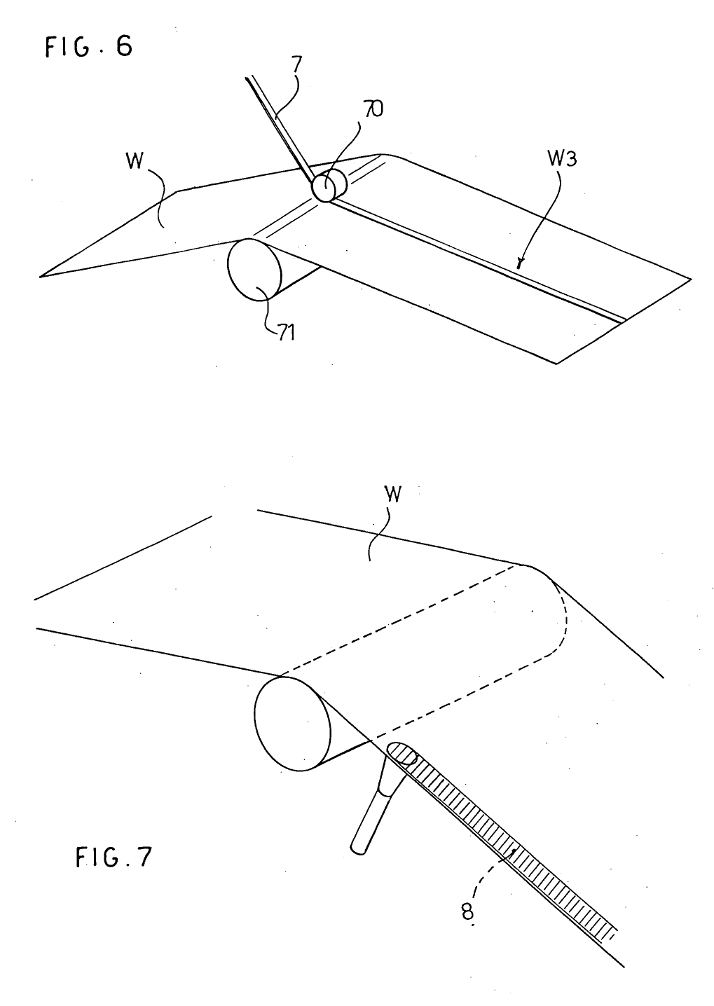

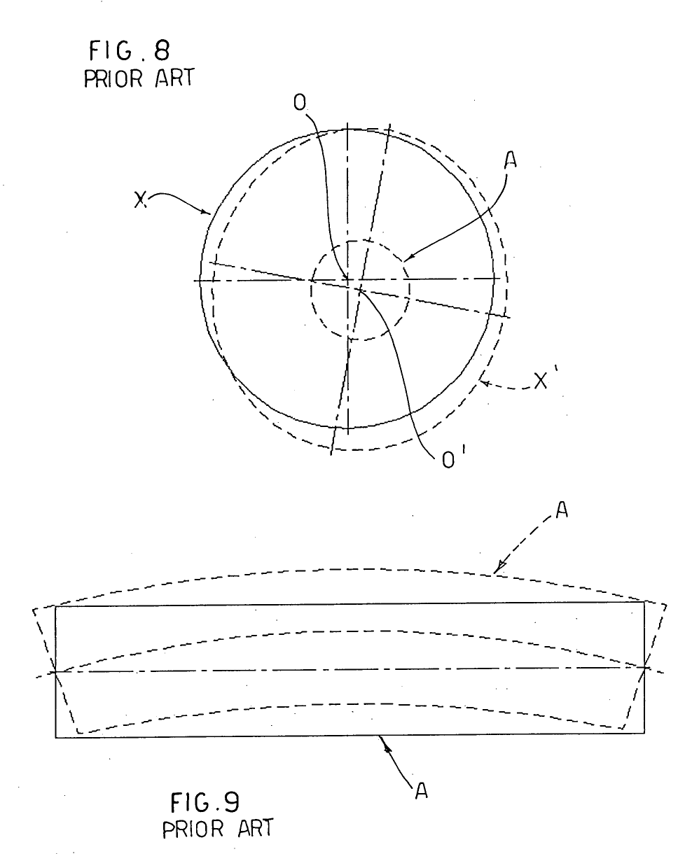

FIG. 6 shows superimposing of a strip of paper 7, or other web material, on the web W being unwound. This strip 7 constitutes an addition of material to said web W so as to obtain a strip W3 with a greater thickness. This system is particularly suitable for creating strips with a greater stiffness in intermediate positions on the web W.

Joining of the strip 7 to the portion of web W can be carried out in various ways, for example by means of knurling or embossing after superimposing, by means of two opposed plybonding or embossing rollers 70, 71. Joining of the strip 7 can also be done by inducing an electrostatic charge on the strip 7 or on the portion of web before they are superimposed so as to ensure adhesion until winding, or by means of applying glues—spray or liquid—to the strip or portion of web before superimposing of the strip 7.

FIG. 7 shows spreading of a liquid material 8 (e.g., thick glue, or starch) on a portion of web so as to obtain a strip with greater stiffness and thickness. Together with this treatment an embossing operation can be performed downstream of spreading of the substance so as to obtain a further increase in thickness and volume of the same portion of web.

By inverting the sequence of the two operations it is possible to have an increase in volume due to the embossing and a subsequent stabilisation of the profile by means of spreading of glue, starch and other suitable substances.

Changes and modifications of detail within the reach of a person skilled in the art can be made to the present embodiments of the invention without thereby departing from the scope of the invention as set forth in the appended claims.

We claim:

1. A stiffening device for a web of sheet material destined to be wound in a log by a winding unit of a re-winding machine, said stiffening device including means for generating on the web at least one longitudinal strip with greater stiffness, so as to obtain in said log at least one sector with greater thickness to avoid deformation of the log during winding.

2. A stiffening device according to claim 1, characterised in that said generating means generates on the web two longitudinal strips with a greater thickness at the side edges of said web so as to obtain in said log two sectors with a grater thickness at its outer edges.

3. A stiffening device according to claim 2, characterised in that said generating means comprises at least one folding unit able to generate folding and superimposing of a side edge of the web so as to obtain said longitudinal strip with a greater thickness.

4. A stiffening device according to claim 3, characterised in that said folding unit comprises a folding roller disposed so that the side edge of the web protrudes outwards with respect to the lateral end of the folding roller and a folding plate shaped so as to guide folding and superimposing of the side edge of the web.

5. A stiffening device according to claim 3, characterised in that said folding unit includes an air blowing device and an air suction device to facilitate folding of the side edge of the web.

6. A stiffening device according to claim 4, characterised in that said folding unit includes an air blowing device and an air suction device to facilitate folding of the side edge of the web.

7. A stiffening device according to claim 4, characterised in that said folding roller includes at its ends a circular supporting sector adapted to be rotated between a folding position in which it does not interfere with the side edge of the web allowing folding thereof and a non-folding position in which it provides a support for the side edge of the web preventing folding thereof.

8. A stiffening device according to claim 5, characterised in that said folding roller includes at its ends a circular supporting sector adapted to be rotated between a folding position in which it does not interfere with the side edge of the web allowing folding thereof and a non-folding position in which it provides a support for the side edge of the web preventing folding thereof.

9. A stiffening device according to claim 3, including at least one sensor unit placed upstream of said folding unit to detect the position of the side edge of the web and accordingly to send a control signal to a control unit which controls the movement of said folding unit

10. A stiffening device according to claim 9, characterised in that said sensor unit comprises a pair of side-by-side sensors placed near the side edge of the web, and actuator means for moving said sensor unit so that the side edge of the web is always between said two sensors.

11. A stiffening device according to claim 3, including at least one knurling or embossing unit disposed downstream of said folding unit to perform knurling or embossing of said folded and superimposed side edge, so as to ensure adhesion thereof until winding.

12. A stiffening device according to claim 11, characterised in that said knurling or embossing unit is operatively connected to a control unit in order to move laterally according to a control signal sent by said control unit.

13. A stiffening device according to claim 3 including at least one electrostatic charge generating device able to generate an electrostatic charge on a portion of web before superimposing of the folded side edge, so as to ensure adhesion thereof until winding.

14. A stiffening device according to claim 3 including at least one glue applying device able to apply a layer of glue to a portion of the web before superimposing of the folded side edge, so as to ensure adhesion thereof until winding.

15. A stiffening device according to claim 1 including at least one starching unit able to deposit a longitudinal strip of starch or other substances on said web and a least one embossing unit able to perform embossing of the web upstream or downstream of said starched strip, so as to obtain said longitudinal strip with greater stiffness and thickness due to the embossing imprint.

16. A stiffening device according to claim 1 including at least one material applying device, able to apply a strip of added material so as to obtain said longitudinal strip with greater stiffness.

17. A stiffening device according to claim 16, characterised in that said strip of added material comprises a solid material.

18. A stiffening device according to claim 16, characterised in that said strip of added material comprises a liquid material.

19. A stiffening device according to claim 1, characterised in that said longitudinal strip of the web with a greater thickness has a width between 5 mm and 50 mm.

20. A method of stiffening a web of sheet material destined to be wound in a log by a winding unit of a re-winding machine, comprising the step of generating on the web at least one longitudinal strip with a greater thickness, before the stage of winding, so as to obtain in said log at least one sector with a greater thickness so as to avoid deformation of the log during winding.

21. A method according to claim 20, characterised in that it comprises generating two longitudinal strips with a greater stiffness at the side edges of said web, so as to obtain in said log two sectors with greater stiffness at the outer side edges thereof.

22. A method according to claim 20, characterised in that it comprises a step of folding and superimposing at least one side edge of the web, so as to obtain said at least one longitudinal strip with greater stiffness.

23. A method according to claim 22 including the step of detecting the position of the side edge of the web and accordingly to control folding of the side edge of the web.

24. A method according to claim 22 including the step of knurling or embossing said at least one folded and superimposed side edge, so as to ensure adhesion thereof until winding.

25. A method according to claim 22 including the step of generating an electrostatic charge on a portion of the web before superimposing of the folded side edge, so as to ensure adhesion thereof until winding.

26. A method according to claim 22 including the step of applying a layer of glue on a portion of the web before superimposing the folded side edge, so as to ensure adhesion thereof until winding.

27. A method according to claim 20 including the steps of depositing a longitudinal strip of starch or other suitable substances on said web and embossing or knurling performed before or after said step of starching, so as to obtain said longitudinal strip with a greater stiffness and thickness.

28. A method according to claim 20 including the step of applying a strip of added material, so as to obtain said longitudinal strip with greater stiffness and thickness.

29. A method according to claim 28, characterised in that said strip of added material comprises a solid material.

30. A method according to claim 28, characterised in that said strip of added material comprises a liquid material.

31. A method according to claim 20, characterised in that said longitudinal strip of the web with greater thickness is between 5 mm and 50 mm in width.
